(19) United States
(12) Patent Application Publication
(10) Pub. No.: US 2025/0307292 A1
(43) Pub. Date: Oct. 2, 2025

(54) SYSTEMS AND METHODS FOR CONSOLIDATING APPLICATIONS USED IN AN ORGANIZATION

(71) Applicant: Recolabs Ltd, Tel Aviv (IL)

(72) Inventors: Tal SHAPIRA, Tel-Aviv (IL); Dana HOHENSTEIN, Givatayim (IL); Eyal ASULIN, Tel-Aviv (IL)

(73) Assignee: Recolabs Ltd, Tel Aviv (IL)

(21) Appl. No.: 19/097,011

(22) Filed: Apr. 1, 2025

Related U.S. Application Data
(63) Continuation of application No. 18/624,175, filed on Apr. 2, 2024, now abandoned.

(51) Int. Cl. H04L 9/40; G06F 16/334; G06F 16/951

(52) U.S. Cl. CPC G06F 16/3347; G06F 16/951

(57) ABSTRACT

A computing system for consolidating software services, the system comprises a memory and a processor configured to collecting data records from computer applications, each record includes a name of a software service, for each data record, search on a database using a search query that includes the software service name, converting text from search results into a numeric vector, performing a similarity comparison between the numeric vector and vectors stored in a service database, the vectors represent description of known software services, creating a candidate list including candidate software services having a similarity score higher than a threshold, inputting information on the candidate software services into a model that determines whether one of the candidate software services matches the software service of the data record, enabling or disabling use of the software service based on policies on the selected candidate software service.

### CROSS-REFERENCE TO RELATED APPLICATIONS

This application is a continuation-in-part of U.S. patent application Ser. No. 18/624,175 filed Apr. 2, 2024, which is hereby incorporated by reference.

### FIELD OF THE INVENTION

The invention, in some embodiments thereof, relates to applications operating in organizations and, more specifically, but not exclusively, to systems and methods for identifying unsanctioned applications in organizations.

### BACKGROUND

Enterprises use internet-based services, such as Office365, Box, Salesforce, Slack and others, to improve the organization's productivity, collaboration and business application workloads. Employees may use different internet-based services to achieve the same functionality, such as Zoom and Microsoft Teams to perform video conferences. However, the organization wishes all the employees to use the same application for regulatory matters, to verify that all the applications operating in the organization are sanctioned apps, which are software applications that have been officially approved or authorized for use within an organization or by a governing body. However, organizations find it challenging to monitor all the entities' activity to check that all the applications used in the organization are sanctioned apps.

### SUMMARY

In one aspect of the invention a computing system is provided for detecting shadow applications operating in devices used by an organization, the system including a memory and a processor, configured to collect from resources used by an organization a data record of a software service used by identities of the organization; inputting text extracted from the data record into a language model configured to identify whether the data record is related to a known software service or a new software service; if the data record is related to a known software service, update a service database to apply policies of the known software service to the service related to the data record; and if the instance is not related to the known software service, create a new generic app ID and updating the service database with a new generic app ID.

In case the software service included in the instance is associated with a known software service, the service database may be updated by assigning security policies of the known software service on the new software service. In some cases, the processor is further configured to perform a similarity search between a vector representing the instance and vectors that represent known software services in the service database. In some cases, the similarity search is a semantic similarity search. In some cases, the processor is further configured to collect additional information from web-based resources about the software services appearing in the instance; perform a similarity search between a vector representing the additional information from web-based resources and vectors that represent known software services in the service database. In some cases, the processor is further configured to filter software services inputted into the language model according to an output of the similarity search.

In another aspect of the invention a method is provided for detecting shadow applications operating in devices used by an organization, the method including collecting from resources used by an organization a data record of a software service used by identities of the organization; inputting text extracted from the data record into a language model configured to identify whether the data record is related to a known software service or a new software service; if the data record is related to a known software service, updating a service database to apply policies of the known software service to the service related to the data record; if the instance is not related to the known software service, creating a new generic app ID and updating the service database with a new generic app ID.

In case the software service included in the instance is associated with a known software service, the service database may be updated by assigning security policies of the known software service to the new software service. In some cases, the method further comprises performing a similarity search between a vector representing the instance and vectors that represent known software services in the service database. In some cases, the similarity search is a semantic similarity search. In some cases, the method further comprises collecting additional information from web-based resources about the software services appearing in the instance; performing a similarity search between a vector representing the additional information from web-based resources and vectors that represent known software services in the service database. In some cases, the method further comprises filtering software services inputted into the language model according to an output of the similarity search.

Embodiments include a computing system for consolidating software services, the system comprises a memory and a processor configured to collecting data records from computer applications, wherein each record of the data records includes a name of a software service. For each of the data records, performing a search on a database using a search query that includes a respective name of the software service, converting text from results of the search into a numeric vector, performing a similarity comparison between the numeric vector and a plurality of vectors stored in a service database, the plurality of vectors represent description of known software services, the similarity comparison outputs a plurality of similarity scores, each similarity score of the plurality of similarity scores is related to a software service of the known software services; creating a candidate software services list including candidate software services having a similarity score higher than a threshold, inputting information on the candidate software services of the candidate software services list into a model that determines whether one of the candidate software services matches the software service of the data record, enabling or disabling use of the software service based on policies on the selected candidate software service.

In some cases, the results of the search include a domain name and text summarizing content in a Uniform Resource Locator (URL) of the result. In some cases, the service database stores identifier for each of the known software services, a vector representing each of the known software services and a domain name of each of the known software services. In some cases, the processor further computes similarity score of results of the search as a function of outputs of the similarity comparison and a rank of the results in the search.

In some cases, the processor is configured to perform an audit of software services in an organization, wherein the audit begins by collecting the data records and outputting approval or disapproval for using a specific software service of the software services in the organization.

In some cases, in case the domain name of the software service does not appear in the service database as related to the known software service, the processor is configured add a new software service record to the service database, the new software service record comprising the domain name, description of the software service extracted from the search results and a vector representing the description.

In some cases, the database is an internet search engine. In some cases, the database stores content copied from internet web pages. In some cases, the information on software services of the candidate software services list includes a name, a domain name and description. In some cases, the numeric vector comprises a predefined number of characters from a predefined number of search results.

Embodiments include a computing method for consolidating software services, the method comprises collecting data records from computer applications, wherein each record of the data records includes a name of a software service, for each of the data records, performing a search on a database using a search query that includes a respective name of the software service, converting text from results of the search into a numeric vector, performing a similarity comparison between the numeric vector and a plurality of vectors stored in a service database, the plurality of vectors represent description of known software services, the similarity comparison outputs a plurality of similarity scores, each similarity score of the plurality of similarity scores is related to a software service of the known software services; creating a candidate software services list including candidate software services having a similarity score higher than a threshold, inputting information on the candidate software services of the candidate software services list into a model that determines whether one of the candidate software services matches the software service of the data record, enabling or disabling use of the software service based on policies on the selected candidate software service.

In some cases, the results of the search include a domain name and text summarizing content in a Uniform Resource Locator (URL) of the result.

In some cases, the method comprises storing an identifier for each of the known software services, a vector representing each of the known software services and a domain name of each of the known software services.

In some cases, the method comprises computing a similarity score of results of the search as a function of outputs of the similarity comparison and a rank of the results in the search.

In some cases, the method comprises performing an audit of software services in an organization, wherein the audit begins by collecting the data records and outputting approval or disapproval for using a specific software service of the software services in the organization.

In some cases, in case the domain name of the software service does not appear in the service database as related to the known software service, the processor is configured add a new software service record to the service database, the new software service record comprising the domain name, description of the software service extracted from the search results and a vector representing the description.

In some cases, the database is an internet search engine. In some cases, the database stores content copied from internet web pages. In some cases, the information on software services of the candidate software services list includes a name, a domain name and description. In some cases, the numeric vector comprises a predefined number of characters from a predefined number of search results.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a flowchart of a method of consolidating software services used in an organization, in accordance with some embodiments;

FIG. 2 shows a flowchart of a method of checking if a software service is already stored in a database of software services used in an organization, in accordance with some embodiments;

FIG. 3 shows a computing system for consolidating software services used in an organization, in accordance with some embodiments; and

FIG. 4 shows a flowchart of a method of consolidating software services used in an organization based on database search, in accordance with some embodiments.

### DETAILED DESCRIPTION

At least some embodiments of the invention described herein address the technical problem of discovering SaaS applications being used in an organization, discovering which person and/or service uses each application and how and discovering the data being accessed and data risks. Understanding the array of applications utilized within an organization is no longer a luxury but a necessity. Shadow Applications are applications used without official organizational approval. They pose significant challenges, including heightened cybersecurity threats, critical data exposure, compliance issues, operational inefficiencies, and elevated costs. Identifying and managing these shadow applications is often complex due to the different names that the same application may have across various audit logs, such as Google Workspace, Microsoft 365, Okta, Salesforce, etc.

One technical solution is a computing system and method configured to create and use Graph analytics and generative AI to provide a contextualized SaaS security solution that links together apps, identities, and data. The computing system collects usage information about entities in an organization, for example via identity provider services, administration logs, and the like. The computing system then extracts the name of the service, collects additional information about the service from web-based resources, and inputs the additional information into a language model configured to identify whether or not the application belongs to a general application ID (also referred to as “app ID”). If the application belongs to a known app ID, apply the set of permissions of the app ID to the examined application. if the examined application does not belong to a known app ID, create a new app ID with the information known about the examined application.

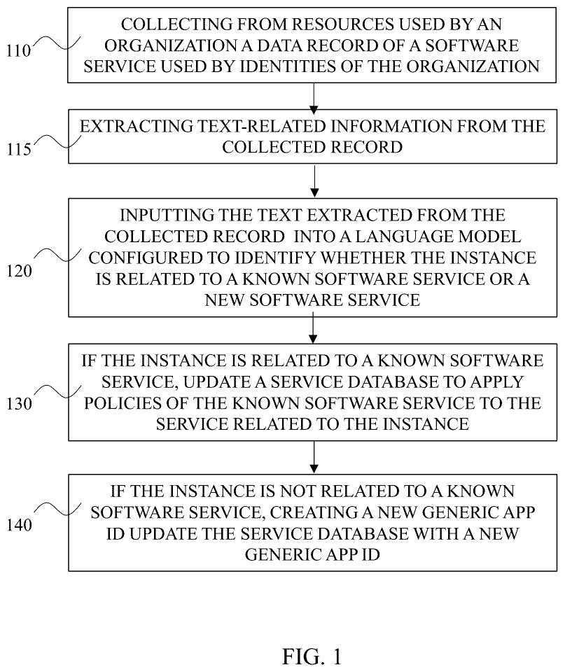

FIG. 1 shows a flowchart of a method of consolidating software services used in an organization, in accordance with some embodiments of the invention.

Step 110 discloses collecting from resources used by an organization a data record of a software service used by identities of the organization. The resources may be incoming email messages, Identity Providers (IDPs), APIs to services, activity logs from operation systems of devices used by the entities in the organization, activity logs & API calls from internet services (apps), and the like. Identity Providers are centralized services that manage user identities and authentication for accessing various applications and resources within an organization's IT infrastructure or across different systems, such as Okta, Google Workspace and the like.

The entities may be persons, virtual entities, bots, services, and the like. The collection may be implemented by receiving a file from the resource, loading data into a file, sending a message to an account or device operated by the organization, updating a memory address of a device or virtual machine operated by the organization, and the like.

Step 115 discloses extracting text-related information from the collected record. The text may be extracted using a parser, a software model, and the like.

Step 120 discloses inputting the text extracted from the collected record into a language model configured to identify whether the instance is related to a known software service or to a new software service. The language model may be a large language model having at least one million parameters. The record comprises the name of the software service as appearing when used by the entity of the organization. The name may include the name of the company that owns or operates the software service, a software service name, a software service label, a software service display name, an internet domain name, a software service vendor, a brand or commercial text describing the software service, the name of an affiliate through which the organization uses the software service, and a combination of the above.

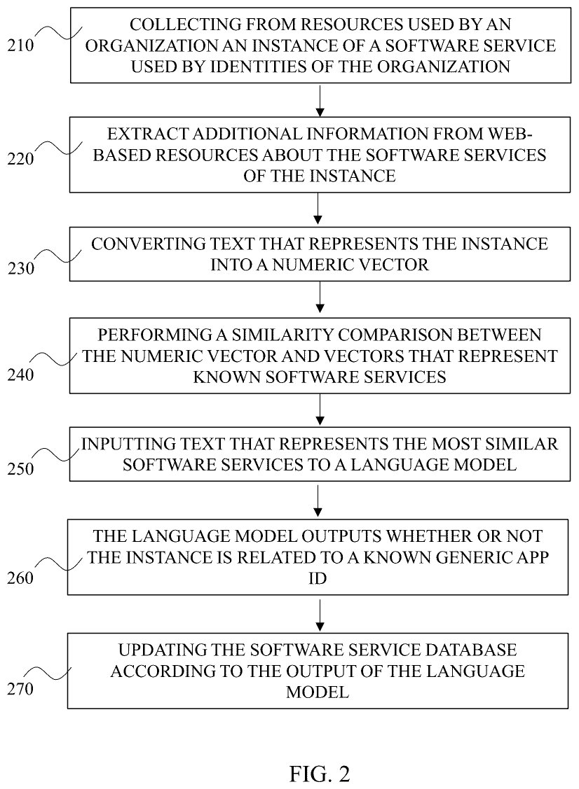

When identifying whether the instance of the software service is related to a known software service or a new software service, the language model may identify a generic app ID from the collected instance and check whether the generic app ID already exists in a service database that stores names and metadata of software services used in the organization, as elaborated in FIG. 2.

Step 130 discloses updating a service database to apply policies of the known software service to the service related to the instance. This process is performed if the instance is related to a known software service by having the same generic app ID. The policies may include access permissions and other actions that may be performed on or by the software service. The policies may vary among different entities of the organization, for example, some entities can just view contents in the software service while other entities can edit and/or share the contents. In such a case, the service database is also updated by mapping the instance to the generic app ID already stored in the service database.

Step 140 discloses creating a new generic app ID and updating the service database with a new generic app ID. This process is performed in case the software service of the instance is not related to a known software service. The new generic app ID is added to the service database along with additional data included in the collected instance, for example, additional service name, IP address of the service, domain name, and the like. The new generic app ID may include a vector representing text, for example, the service name, and additional information extracted from web-based services. The vector associated with the new generic app ID can be used to identify new records of a software service as related to the new generic app ID.

The collected data records comprise one or more data fields known to include unique identifiers of the software service. The unique identifier may be an alphanumeric value. The data field may be “app principal”, “app ID” and the like. After the first time the unique identifier is associated with a generic app ID in the service database, additional instances that include the same unique identifier are automatically associated with the same generic app ID.

FIG. 2 shows a flowchart of a method of checking if a software service is already stored in a database of software services used in an organization, in accordance with some embodiments of the invention.

Step 210 discloses collecting from resources used by an organization an instance of a software service used by identities of the organization. The resources may be incoming email messages, Identity Providers (IDPs), APIs to services, activity logs from operation systems of devices used by the entities in the organization, and the like. Identity Providers are centralized services that manage user identities and authentication for accessing various applications and resources within an organization's IT infrastructure or across different systems, such as Okta, Google Workspace and the like.

Step 220 discloses extracting additional information from web-based resources about the software services of the instance. The extraction may be done using a web scraper or by accessing a known database or other type of data accessible using a URL. The additional information may be the names of the owner of the service provider, billing addresses of the service provider, physical addresses of the service provider's offices, optional billing plans offered by the service provider, and the like.

Step 230 discloses converting text that represents the instance into a numeric vector. The conversion may be performed in a technique desired by a person skilled in the art, for example using Bag of Words (BoW), Word Embeddings, Sentence Embeddings, TF-IDF (Term Frequency-Inverse Document Frequency), N-grams, Hashing Vectorizer, Character-level Embeddings, Topic Modeling, large language model, a small language model (or other deep learning models) and the like.

Step 240 discloses performing a similarity comparison between the numeric vector and vectors that represent known software services. The vectors may be stored in a database or a memory storage accessed by the machine or device that performs the similarity comparison. The output of the comparison may be a numeric value. The comparison may be performed in a technique desired by a person skilled in the art, for example, Cosine Similarity, Euclidean Distance, Manhattan Distance, Jaccard Similarity, Hamming Distance, Levenshtein Distance, Minkowski Distance, Correlation Coefficient.

Step 250 discloses inputting text that represents the most similar software services to a language model. The process of inputting the text may be done after a filtering process in which irrelevant results are removed. For example, only the 5 most relevant software services may be inputted into the language model or only software services that have a similarity score that is higher than a threshold. Inputting the text that represents the most similar software services to the language model may be defined as part of a Retrieval-Augmented Generation (RAG) process of optimizing the output of the language model, as the language model receives a knowledge base outside of the model's training data sources before generating a response.

Step 260 discloses the language model outputs whether or not the instance is related to a known generic app ID. The language model outputs a score that represents a likelihood that the instance is related to a known generic app ID. In case the score is higher than a threshold, or in case the score satisfies another condition, the instance is considered to be related to one generic app ID of multiple generic app IDs stored in the service database.

Step 270 discloses updating the software service database according to the output of the language model. For example, updating a service database to apply policies of the known software service to the service related to the instance in case the instance is related to a known software service by having the same generic app ID. In another exemplary case, the updating may comprise updating the service database with a new generic app ID in case the software service of the instance is not related to a known software service.

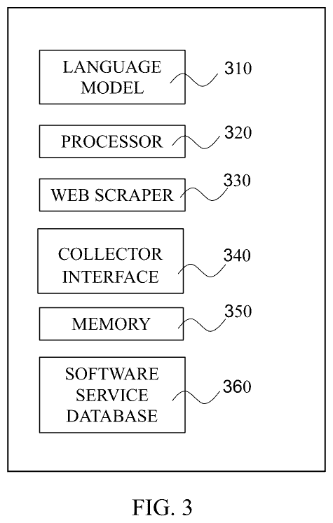

FIG. 3 shows a computing system for consolidating software services used in an organization, in accordance with some embodiments of the invention. In various embodiments, the computing system described above performs a specific process for consolidating software services described in greater detail herein. In certain embodiments, the consolidating of software services enables applying security policies on relevant services having the same generic app ID, hence improving processor efficiency, and thus the efficiency of the organization's devices. Once the computing system is configured to perform the process for consolidating software services, the computing system becomes a specialized computing device specifically configured to perform the process for consolidating software services and is not a general-purpose computing device.

The computing system comprises language model 310 configured to receive text about an instance of using a software service and output whether the software service of the instance is related to a known software service or is a new software service. The language model 310 may send the output to a processor 320 to update the software database 360. Processor 320 may be any one or more processors such as a Central Processing Unit (CPU), a microprocessor, an electronic circuit, an Integrated Circuit (IC), or the like. The language model 310 is a large language model having at least one million parameters.

The large language model 310 is a type of artificial intelligence system designed to understand and generate text based on vast amounts of training data. The model 310 is created using deep learning techniques, for example, neural networks with many layers and a large number of parameters. The large language model 310 is trained on large datasets of text to learn patterns, structures, and relationships in language. Large Number of Parameters: The term “large” in “large language model” refers to the immense number of parameters (weights and biases) that the model 310 learns during training. These parameters enable the model to capture and represent the intricate patterns and structures of language. The language model 310 may be similar to OpenAI's GPT (Generative Pre-trained Transformer) series, Google's BERT (Bidirectional Encoder Representations from Transformers), and Facebook's RoBERTa (Robustly Optimized BERT Approach). The processes performed by the large language model cannot be performed by the human mind.

Processor 320 may be utilized to perform computations required by the apparatus or any of its subcomponents. The computing system may also comprise a web scraper 330 configured to extract data from web-based resources such as web pages, folders, databases, and the like. The extracted data may be used to consolidate software services extracted from resources used by entities of the organization.

The computing system may also comprise a collector interface 340 configured to collect information from resources used by entities of the organization. The entities may include one or more IDPs (Google Workspace, Microsoft, Okta, and the like), incoming email messages, APIs operated and/or managed by the software services, operation longs of the organization and the like. The information received via the collector interface comprises instances of using software services. The instances are then used to check whether the software service already exists in the service database or is a new service.

The computing system comprises a memory 350. The memory 350 may be a hard disk drive, a Flash disk, a Random Access Memory (RAM), a memory chip, or the like. In some exemplary embodiments, memory 350 can retain program code operative to cause processor 420 to perform acts associated with any of the subcomponents of the computing system.

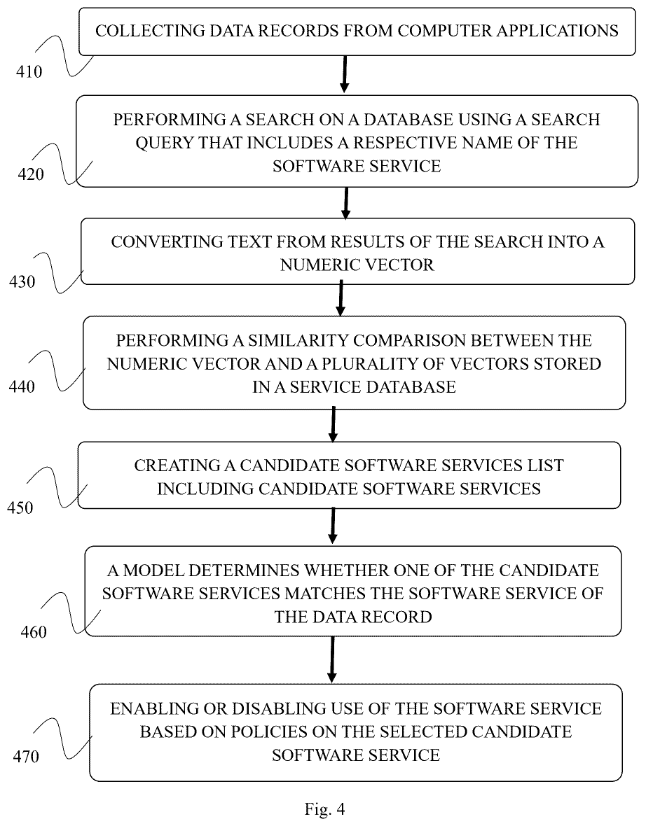

FIG. 4 shows a flowchart of a method of consolidating software services used in an organization based on database search, in accordance with some embodiments.

In operation 410, data records used by entities of the organization may be collected from computer applications. In some embodiments, each record of the data records includes a name of a software service. The data records may be collected at a monitoring server configured to monitor operation of software services in devices, or in organizations. The data records may be a name of a software service as appearing in an event log or in messages related to usage or installing of the software service. The name may be “zoom for office 365”, for example in case a user in an organization installed or accessed the software service Zoom via office 365. The organization may desire to identify the software service included in the message, for example to determine whether or not the software service is allowed to be used in the organization's devices.

In operation 420, a search on a database may be performed using a search query that includes a respective name of the software service. The database may be an internet search engine such as Google, Perplexity, Bing and/or other search engines as are known in the art. The database may be a server comprising data copied from web pages. The database may store information about software services, for example, in a list of software services along with respective usage statistics on the software services in the list.

In operation 430, text from results of the search may be converted into a numeric vector. The text may include a predefined number of characters from the first number of search results. For example, 200 first characters from the first 12 results. In some cases, the extraction of text from the search results may include filtering sponsored results, for example paid ads. In some embodiments, each search result is associated with a domain name and a text summarizing the content in the URL. The conversion may be performed according to methods as are known in the art, for example using Bag of Words (BoW), Word Embeddings, Sentence Embeddings, TF-IDF (Term Frequency-Inverse Document Frequency), N-grams, Hashing Vectorizer, Character-level Embeddings, Topic Modeling, large language model, a small language model (or other deep learning models). The conversion method can be an input to the system executing the processes described herein.

In operation 440, a similarity comparison may be performed between the numeric vector and a plurality of vectors stored in a service database. The similarity comparison may utilize a similarity function such as cosine similarity, kernel functions and additional similarity functions. The plurality of vectors can represent a description of known software services used in the organization. The similarity comparison may output a plurality of similarity scores, each similarity score of the plurality of similarity scores is related to a software service of the known software services. For example, the service database stores 120 known software services, the similarity comparison may output 120

[symbol]

The service database can include a unique identifier for each software service stored in the service database, a unique vector representing the software service and a respective domain name of the software service. The vectors from the search results may be compared with all the vectors in the service database. In some embodiments, the similarity score is a function of the output of the similarity function and a rank of the vector in the search result (e.g., vectors 1-5 are presented as the result of the search and vector 2 is ranked first, vector 4 is ranked second, vector 5 is ranked third, vector 1 is ranked fourth and vector 3 is ranked fifth). Weighted sum of the ranking, similarity for each domain.

In operation 450, a candidate software services list may be created to include software services having a similarity score that is above a threshold. The threshold may be predefined, for example 0.7, and/or limited to a number of top results, for example top 3 results are included in the candidate software services list.

In operation 460, information on the candidate software services list may be input into a model that determines whether one of the candidate software services matches the software service. The model is trained to identify a domain name related to the software service. The information may include a name, a domain name and description of the software service. for example, the list of software service candidates include “zoom.us”, “zoom.com” and “Microsoft.com”. The three candidates may already be included in the service database. In case the domain name of the software service as output by the model does not appear in the service database, the model outputs the domain and description of the software service. The description is then converted to vector to be used in the similarity comparison for the future messages.

In operation 470, the software service is enabled or disabled based on policies on the selected candidate software service. The enable/disable decision may apply to a limited number of entities, for example only entities in the same department or country as the entity from which the message was received. The enable/disable decision may also be defined as Approve/decline usage of the specific software service. The enable/disable decision may be based on a domain name of the candidate software services that matches the software service of the data record. for example, Chat GPT cannot be connected to any software service operating in the organization, and the GPT is written differently data records of each organizational application. The method described herein enables preventing a plurality of instances of representing the “chat GPT” domain.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant files and/or records will be developed and the scope of the term file and/or record is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended that the invention embraces all such alternatives, modifications and variations.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the invention. To the extent that section headings are used, they should not be construed as necessarily limiting. In addition, any priority document(s) of this application is/are hereby incorporated herein by reference in its/their entirety.

What is claimed is:

1. A computing system for consolidating software services, the system comprises a memory and a processor configured to collecting data records from computer applications, wherein each record of the data records includes a name of a software service, for each of the data records,
i. performing a search on a database using a search query that includes a respective name of the software service,
ii. converting text from results of the search into a numeric vector,
iii. performing a similarity comparison between the numeric vector and a plurality of vectors stored in a service database, the plurality of vectors represent description of known software services, the similarity comparison outputs a plurality of similarity scores, each similarity score of the plurality of similarity scores is related to a software service of the known software services;
iv. creating a candidate software services list including candidate software services having a similarity score higher than a threshold,
v. inputting information on the candidate software services of the candidate software services list into a model that determines whether one of the candidate software services matches the software service of the data record, enabling or disabling use of the software service based on policies on the selected candidate software service.

2. The system of claim 1, wherein the results of the search include a domain name and text summarizing content in a Uniform Resource Locator (URL) of the result.

3. The system of claim 1, wherein the service database stores identifier for each of the known software services, a vector representing each of the known software services and a domain name of each of the known software services.

4. The system of claim 1, wherein the processor further computes similarity score of results of the search as a function of outputs of the similarity comparison and a rank of the results in the search.

5. The system of claim 1, wherein the processor is configured to perform an audit of software services in an organization, wherein the audit begins by collecting the data records and outputting approval or disapproval for using a specific software service of the software services in the organization.

6. The system of claim 1, wherein in case the domain name of the software service does not appear in the service database as related to the known software service, the processor is configured add a new software service record to the service database, the new software service record comprising the domain name, description of the software service extracted from the search results and a vector representing the description.

7. The system of claim 1, wherein the database is an internet search engine.

8. The system of claim 1, wherein the database stores content copied from internet web pages.

9. The system of claim 1, wherein the information on software services of the candidate software services list includes a name, a domain name and description.

10. The system of claim 1, wherein the numeric vector comprises a predefined number of characters from a predefined number of search results.

11. A computing method for consolidating software services, the method comprises collecting data records from computer applications, wherein each record of the data records includes a name of a software service, for each of the data records,
performing a search on a database using a search query that includes a
respective name of the software service,
converting text from results of the search into a numeric vector, performing a similarity comparison between the numeric vector and a plurality of vectors stored in a service database, the plurality of vectors represent description of known software services, the similarity comparison outputs a plurality of similarity scores, each similarity score of the plurality of similarity scores is related to a software service of the known software services;
creating a candidate software services list including candidate software services having a similarity score higher than a threshold, inputting information on the candidate software services of the candidate software services list into a model that determines whether one of the candidate software services matches the software service of the data record, enabling or disabling use of the software service based on policies on the selected candidate software service.

12. The method of claim 11, wherein the results of the search include a domain name and text summarizing content in a Uniform Resource Locator (URL) of the result.

13. The method of claim 11, comprising storing an identifier for each of the known software services, a vector representing each of the known software services and a domain name of each of the known software services.

14. The method of claim 11, comprising computing a similarity score of results of the search as a function of outputs of the similarity comparison and a rank of the results in the search.

15. The method of claim 11, comprising performing an audit of software services in an organization, wherein the audit begins by collecting the data records and outputting approval or disapproval for using a specific software service of the software services in the organization.

16. The method of claim 11, wherein in case the domain name of the software service does not appear in the service database as related to the known software service, the processor is configured add a new software service record to the service database, the new software service record comprising the domain name, description of the software service extracted from the search results and a vector representing the description.

17. The method of claim 11, wherein the database is an internet search engine.

18. The method of claim 11, wherein the database stores content copied from internet web pages.

19. The method of claim 11, wherein the information on software services of the candidate software services list includes a name, a domain name and description.

20. The method of claim 11, wherein the numeric vector comprises a predefined number of characters from a predefined number of search results.
